(19) United States
(12) Patent Application Publication
(10) Pub. No.: US 2015/0112847 A1
(43) Pub. Date: Apr. 23, 2015

(54) TRADE EXECUTION METHODS AND SYSTEMS

(71) Applicant: SEA CAPITAL LLC, Corona Del Mar, CA (US)

(72) Inventors: Alvin Choi, Corona Del Mar, CA (US); Erik Shirley, Corona Del Mar, CA (US)

(73) Assignee: SEA CAPITAL LLC, Corona Del Mar, CA (US)

(21) Appl. No.: 14/058,019

(22) Filed: Oct. 18, 2013

(51) Int. Cl. G06Q 40/04

(52) U.S. Cl. CPC G06Q 40/04
USPC 705/37

(57) ABSTRACT

A computer system for electronic trading system is disclosed. The computer system allows the user to predefine various parameters that dictate trade entry as well as exits of a trade based on risk sizing and/or a risk versus reward schedule. By entering and exiting trades based on predefined parameters, the emotion of trading is reduced and the user is allowed to spend more time looking for other profitable trades than monitoring live open trades.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The systems and methods described herein relate to an electronic securities trading system.

Securities trading encompasses day trading. In day trading, a real-time data feed is downloaded for the purpose of entering and exiting trades for a particular market. Fear and greed are emotions that may drive a particular market up or down but are considered distractors for profitable securities trading including but not limited to day trading.

Computer systems with software for downloading the real-time data feed, entering and exiting trades exist but have limited capabilities to help a retail trader (i.e. novice) reduce or eliminate emotion and holding to predetermined buy and sell parameters when entering or exiting a trade.

Accordingly, there is a need in the art for an improved computer system and method for reducing or eliminating emotion while trading securities online.

### BRIEF SUMMARY

The various methods and systems described herein address the needs discussed above, discussed below and those that are known in the art.

A computer system with software loaded thereon is provided. The computer system allows the user to predefine risk sizes as well as risk versus reward schedules which can each be used alone or in combination with each other. Each setting may be referred to as a trading profile. The trading profile may be used by the user when entering a trade. The user selects one trading profile when entering a trade. The trading profile determines the size of the trade and may also automatically exit the trade. For a limit order, the system allows the trader to receive a higher probability of getting an order at the specified price compared to other traders to the increased speed of execution. For a market order, the system allows the trader to get a higher priority due to the increased speed of execution. The user is freed up to spend his or her time scanning the markets for more profitable trades. Also, the user is kept to strict standards of entering and exiting a trade.

More particularly, the methods and systems described herein relate to electronic securities trading systems. The computer implementation allows for a “one click” automated trade execution method for both trade entry and exit. One or more features of the computer implementation allows for 1) specific risk sizing based on a fixed percentage of a singular account balance, 2) ability to risk size based on the cumulative monetary risk associated with all open trade in the singular trading account, 3) ability to risk size based on recent highs and lows from a price chart utilizing a bar count look back functionality, 4) ability to risk size based on recent volatility utilizing the average true range (ATR) indicator, 5) ability to automate exit strategies utilizing stop order changes at each risk versus reward (RVR) ratio level to encompass one of the following function(s): regular trail stop, ATR trailing stop, percent retracement stop, bar count look back trail stop and time stop, and 6) ability to apply multiple uniquely identified “one click” automated trade executions for both trade entry and exit.

More particularly, a computer loaded with software for performing the steps of setting up one or more profiles for trading a market based on a risk sizing and risk versus reward schedule; selecting one profile of the one or more profiles; and entering the market based on the selected profile.

The entering step may include the step of limiting a trade second in time based on a risk of at least one trade first in time. The at least one trade first in time may be only for open trades.

The setting up step may include the step of selecting at least one option from a group consisting of one or more of the following options, namely, max sizing option, ATR sizing option, bar count sizing option, commission included sizing option, global risk of all positions sizing option, or combinations thereof.

The setting up step also include the step of selecting at least one option from a group consisting of one or more of the following options, namely, average true range trail stop option, bar count look back trail stop option, percent retracement stop option, time stop option, regular trail stop option, break even stop option or combinations thereof.

The entering step may include at least one of buying a market or stock, selling a market or stock or straddling a market or stock.

In another aspect, a computer loaded with software is disclosed. The software may operate the computer for performing the steps of storing prior trades of a market for a predetermined period into a memory of the computer; selecting a different profile; and testing the stored prior trades for the market based on the selecting step.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of a number of computers receiving a data feed source;

FIG. 2 is a flowchart of a method implemented on the computer;

FIG. 3 is a time bar illustrating subsequent trades being entered as a function of prior trades;

FIG. 4 is a screenshot of a main tab of the software for implementing the steps shown in FIGS. 2 and 3;

FIG. 5 is a screenshot of a systems tab of the software for defining one or more profiles;

FIG. 6 is a screenshot of an open trades tab of the software to view open trades;

FIG. 7 is a screenshot of a sizing tab of the software to define allowable risk for an individual trade to be entered or for any open trades;

FIG. 8 is a screenshot of an RVR tab and a pop up window of the software to define an RVR (risk versus reward) level and combine RVR levels to create a RVR schedule;

FIG. 9A is a screenshot of a pop up window that allows a user to create a Trail Stop RVR;

FIG. 9B is a screenshot of a tab of the pop up window shown in FIG. 9A for defining parameters of the Trail Stop RVR;

FIG. 10A is a screenshot of a pop up window that allows a user to create an ATR RVR;

FIG. 10B is a screenshot of a tab of the pop up window shown in FIG. 9A for defining parameters of the ATR RVR;

FIG. 11A is a screenshot of a pop up window that allows a user to create a Retracement RVR;

FIG. 11B is a screenshot of a tab of the pop up window shown in FIG. 9A for defining parameters of the Retracement RVR;

FIG. 12A is a screenshot of a pop up window that allows a user to create a Break Even RVR;

FIG. 12B is a screenshot of a tab of the pop up window shown in FIG. 9A for defining parameters of the Break Even RVR;

FIG. 13 is a screenshot of the hotkeys tab of the software to view or specify a hotkey;

FIG. 14 is a screenshot of the sounds tab of the software to view or specify a customer sound with available options.

### DETAILED DESCRIPTION

Referring now to the drawings, a computer system 10 and method for entering a market with a predetermined risk size 102 and exiting the market with a predetermined risk versus reward schedule (RVR schedule) 104 are discussed. Each of the computer systems 10 may be in data communication with a data feed source 12 which provides market data to the computer systems 10. The computer systems 10 have software loaded thereon that allows the user to create 100 one or more different profiles as a function of risk sizing 102, risk versus reward schedules 104 or combination thereof that allow the user to enter and exit markets under predetermined parameters. The user is freed to scan 106 a number of markets for potentially profitable trades instead of keeping track of open trades. Once a potentially profitable trade is identified, the user may select 108 one of the custom profiles that might be appropriate for that market and with one click enter 110 and later exit that market based on the predetermined risk sizing 102 and predetermined RVR schedule 104 of the selected profile. The computer system 10 and method disclosed herein allow a retail trader to be more profitable. Emotion is taken out of the trade once entered so that the exits are performed automatically based on the selected profile. The computer executes the exit at a later time based on the criteria (i.e., RVR schedule) of the selected profile. Each trade is done with the preselected risk sizing and exits are made with the preselected risk versus reward schedule. The predetermined profiles allow the user to enter trades with one click thereby allowing the trader or user to enter the market quickly. For both limit and market orders, the trader or user is able to receive a higher probability of receiving an order at a specific price (limit order) or to get a higher priority (market orders). Moreover, subsequent contracts may be entered into while taking into consideration prior live contracts or open trades.

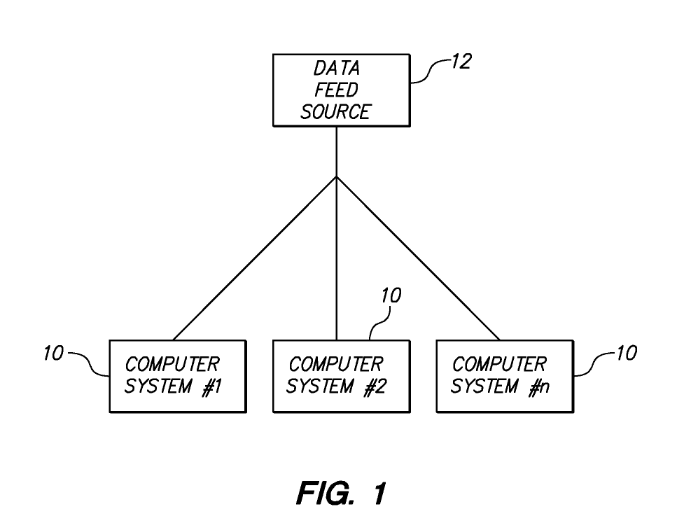

Referring now to FIG. 1, a plurality of computer systems 10 are in data communication with a data feed source 12. This data communication may be established by an Internet connection or with a direct landline connection to the data feed source 12 and the computer system 10 or other communication means known in the art or developed in the future. The data feed source 12 may transmit trading data to the computer systems 10. The trading data includes but is not limited to live market data for markets in the form of tick or pip data. The computer system 10 may have a trading platform software loaded thereon to execute a trade. An add on software that interfaces with the trading platform may perform the various functions described herein. Alternatively, a trading platform software may incorporate all of the features and aspects discussed herein into a single software program.

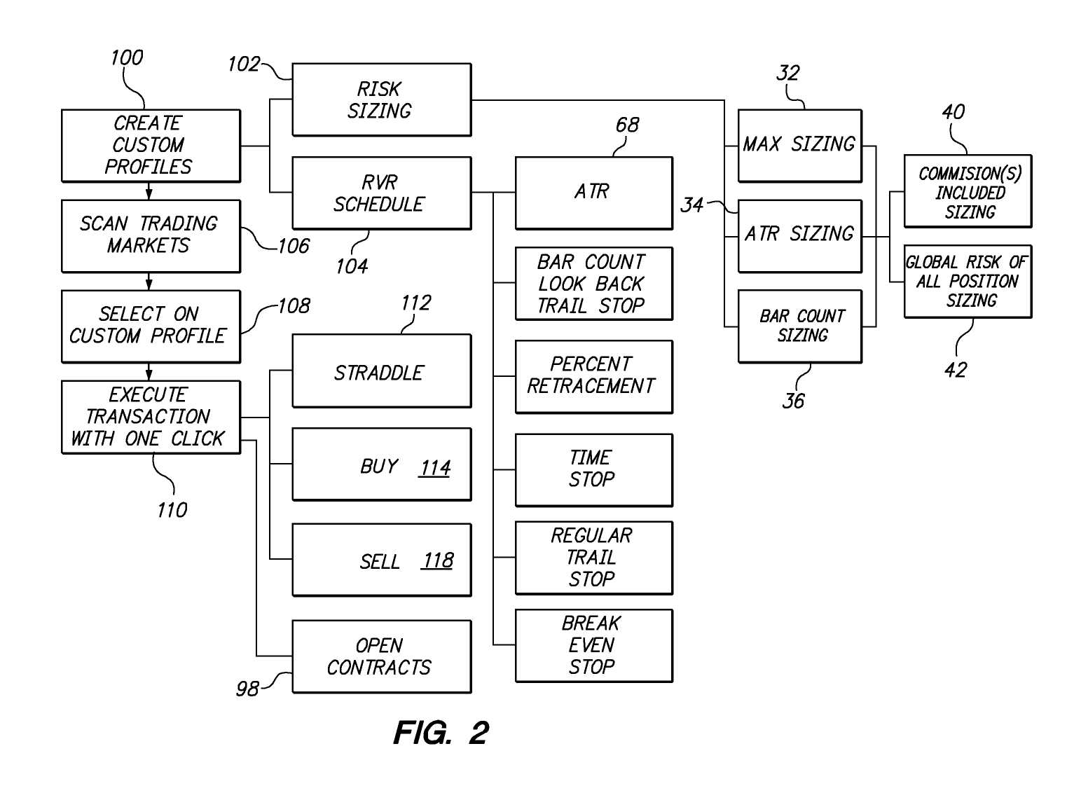

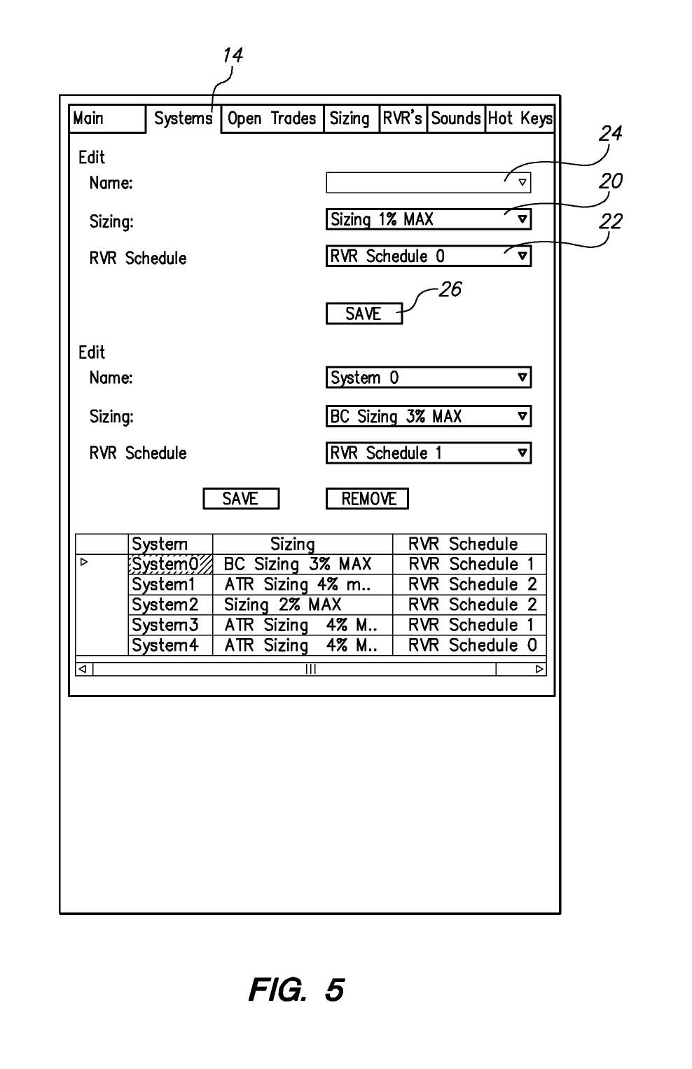

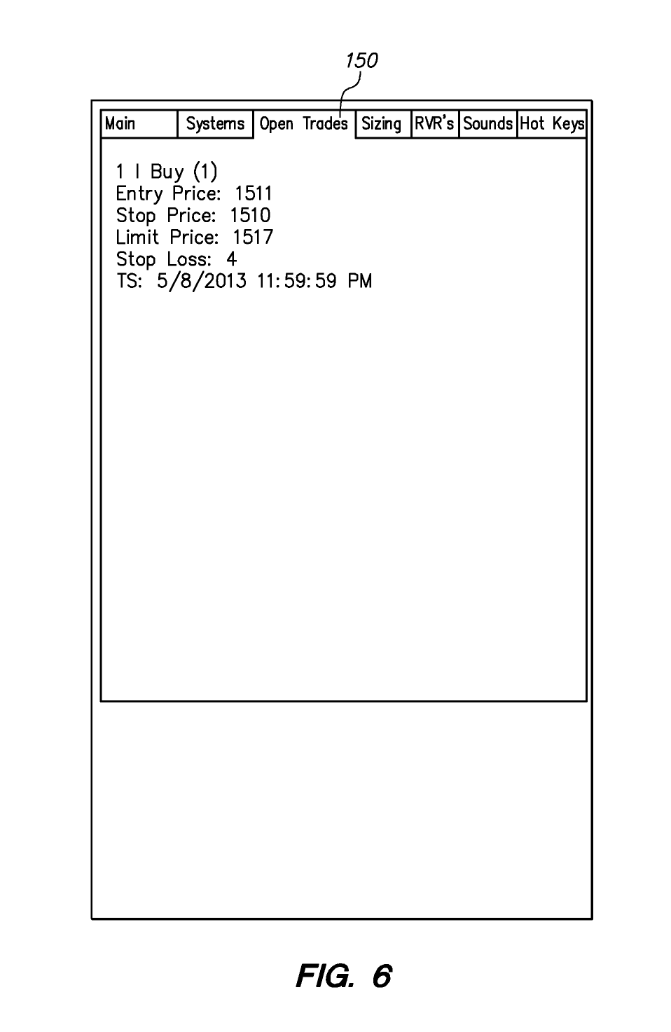

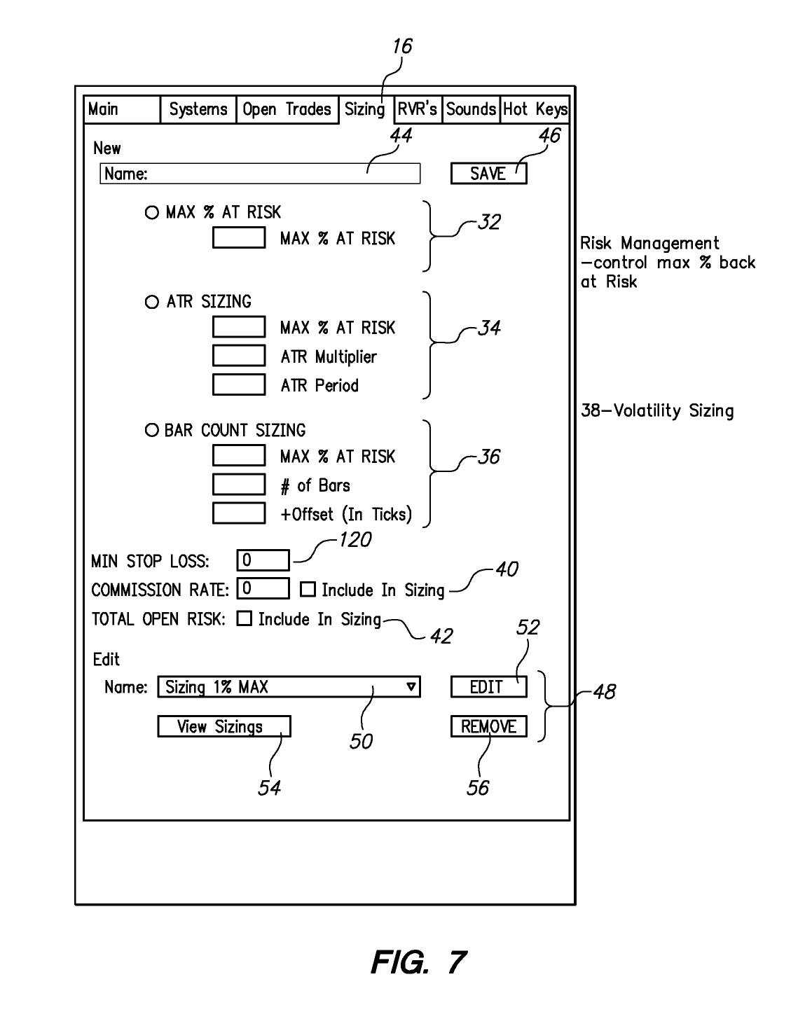

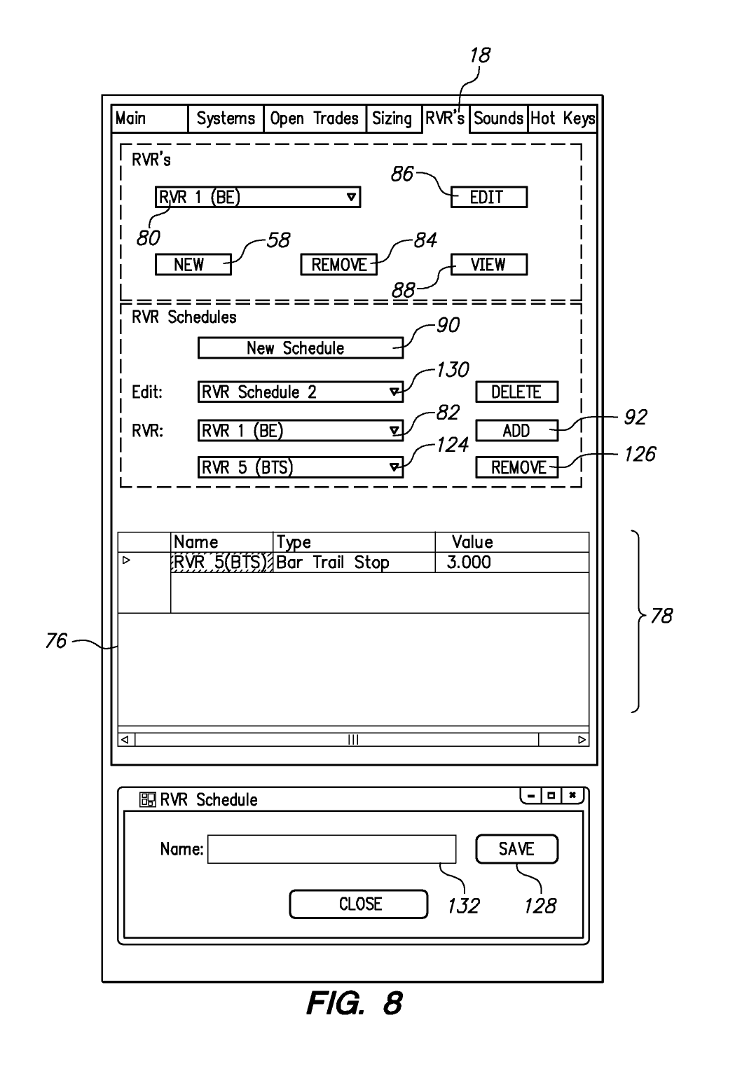

Referring now to FIG. 2, the steps performed by the computer system 10 with software loaded thereon is shown. Prior to trading a market, the user creates 100 one or more custom profiles as a function of risk sizing 102 and RVR schedule 104. These profiles may be created on the system tab 14 shown in FIG. 5, sizing tab 16 shown in FIG. 7 and RVR tab 18 shown in FIGS. 8, 9A, 9B, 10A, 10B, 11A, 11B, 12A and 12B.

Referring now to FIG. 5, the system tab 14 allows the end-user to select from one or more sizing presets 20 and one or more RVR schedule presets 22. After selecting one combination of sizing presets 20 and RVR schedule presets 22, the user may enter a name 24 and click a save button 26. The name may relate to the combination of sizing presets 20 and RVR schedule 22. By way of example and not limitation, the name may be ES Mini Range Bound Market, ES Mini Trending Market or the like. The user may scan 106 one or more markets, quickly identify and select 108 the proper preset profiles 20 from a plurality of profile presets 28 from a main tab 30 (see FIG. 4) through which the user executes 110 a transaction with one click (buy, sell or straddle) to enter the market through the main tab 30 as shown in FIG. 4.

Referring now to FIG. 7, the sizing tab 16 provides the user with a number of options to tailor (i.e., set parameters) the risk sizing presets 20. In particular, the user has a max sizing option 32, ATR sizing option 34 and bar count sizing option 36. Option 32 calculates the number of contracts the trader must trade utilizing only a specific percentage of a trading account to be at risk. By way of example and not limitation, if the specific percentage is set at 2% and the trading account has $50,000, then the number of contracts on a single trade cannot exceed the risk of $1000 at the moment the trade is executed.

The ATR sizing option 34 utilizes the Average True Range Indicator to help in calculating position size. The user may specify the period and the multiplier. The period defines the number of bar back the indicator will look at with respect to the range of price to calculate the average true range. The multiplier is a factor applied to this ATR value to calculate the number of ticks/pips to set the stop loss. The user can override this stop loss calculation by specifying a minimum stop loss 120. The number of ticks/pips, the value of each tick/pip for the market being traded and the percent of account the user is willing to risk are used to calculate the number of contracts a trader can trade per trade.

The bar count sizing option 36 allows the user to risk size accordingly based on the most recent bar count look back pivot highs and lows while adhering to the defined percent of trading account balance at risk per trade. This option 36 allows the user to provide offset parameters so that the user may place a “stop order” with a set tick/pip movement above or below the most recent pivot high or low.

One of the max % at risk 32, ATR sizing 34 and the bar count sizing 36 is selected. Additionally, the user can overlay one or more of the min stop loss option 120, commission included sizing option 40 and the total open risk option 42 on top of any one of the max % at risk 32, ATR sizing 34 and the bar count sizing 36. The minimum stop loss option 120 has been described above.

The commission included sizing option 40 allows the user to factor in the cost of each trade transaction to be included in the correct calculation of contracts to trade while adhering to the defined percent of trading account balance at risk per trade. This function is used in conjunction with max % at risk 32, ATR sizing 34 or bar count sizing 36. Technically, if a user did not account for the cost of the trade transaction then the monetary value at risk plus the cost of trade would essentially be more than the specified percent risk of the trading account balance per trade.

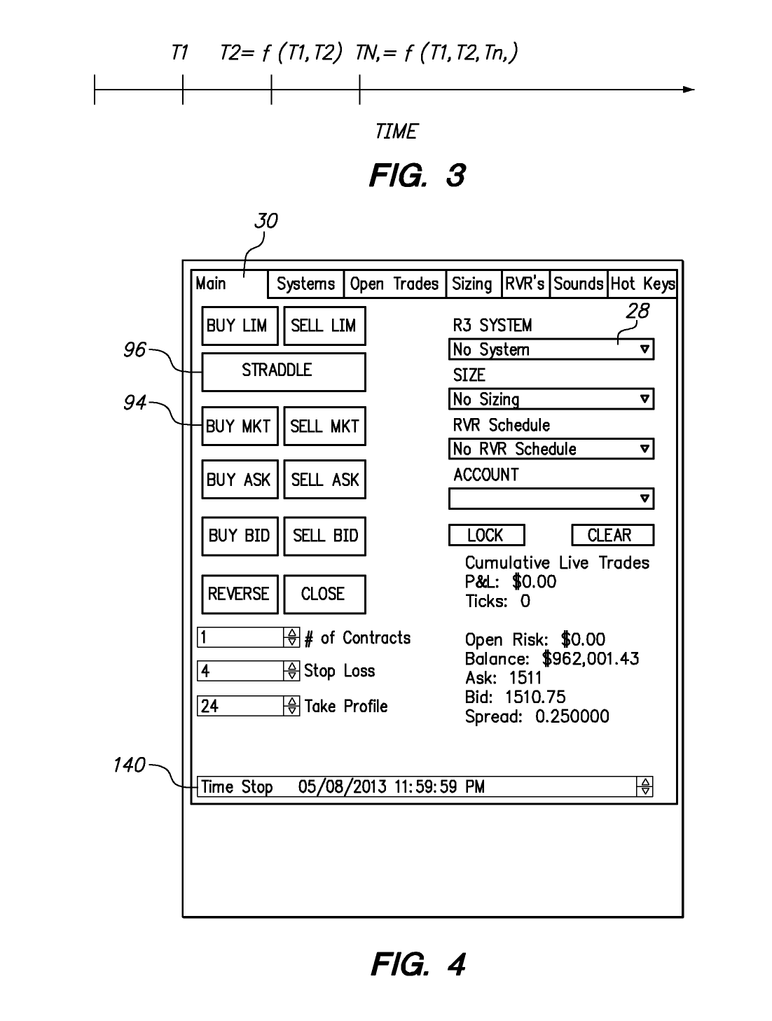

The option 42 for global risk of all positions sizing when elected factors in the worst case scenario with all current live trades and all associated risk on the table in the singular trading account. Computer system 10 will evaluate all other open trades within an account utilizing computer system 10 to see what open risk is outstanding with the current open trades. More particularly, referring now to FIG. 3, a timeline for a number of trades T is shown. To enter the first trade T1, the user selects a profile and clicks either a buy button 94 or a straddle button 96 on the main page 30. Trade T-1 is entered into the system 10. As the user scans one or more markets, the user may identify another potentially profitable trade. At this time, the user selects the appropriate profile and either clicks the buy button 94 or the straddle button 96. The user has the option to execute a trade by pressing any of the following buttons shown in FIG. 4: Straddle, Buy Lim, Sell Lim, Buy MKT, Sell Mkt, Buy Ask, Sell Ask, Buy Bid & Sell Bid. Trade T2 may be made as a function of T1 and T2. By way of example and not limitation, T1 may still be trading within a range that opens the possibility of loss to the user. The maximum potential loss to the user of trade T-1 is subtracted from the total allowable loss defined by the user to determine whether T2 may be entered based on the select profile. If the total potential loss of trade T-1 plus trade T2 is greater than the total allowable laws defined by the user, then trade T2 cannot be entered or the amount of the trade must be reduced to fit within the defined total potential loss parameters set by the user. Each subsequent trade takes into account all open trades a list of which may be shown on the open trades page 150.

Risk sizing is an important part of any trading system. The reason is that with a good, positive expectancy system, most of the profits and losses will come from risk sizing. Expectancy is the average amount of money one plans to make over many trades per dollar risked. The user may typically use a fairly simple system and still be profitable if the positions are adequately sized. Expectancy and probability of winning are not equivalent. In trading, making money is the only goal. However, users have a desire to be right on every trade or investment. As a result, users tend to gravitate towards high entry systems. Yet these systems are also associated with large losses and lead to negative expectancy. Being right does not necessarily mean that you are profitable. A trading account may lose money while being 90% correct.

The user may click on the sizing tab 16 to choose and enter criteria for one of the options 32, 34, 36 along with one or more of the options 40, 120 and 42. Once the options 32, 34, 36, 40, 120 and 42 are set, the user enters in a name 44 and clicks the save button 46. The user may also edit or view the parameters of a particular option 32, 34, 36, 40 and 42 by way of the edit section 48. The user may select a sizing preset 20 from the drop-down list 50 to edit 52 or view 54 the parameters of the sizing preset 20 or remove 56 the sizing preset 20.

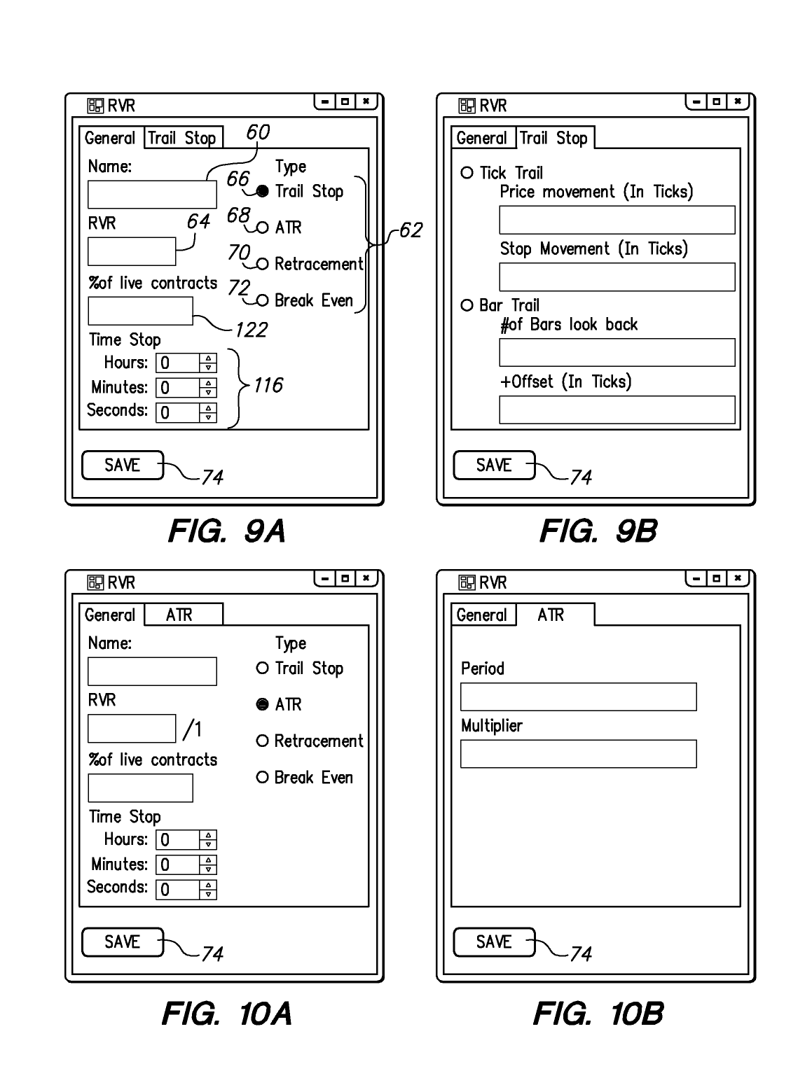

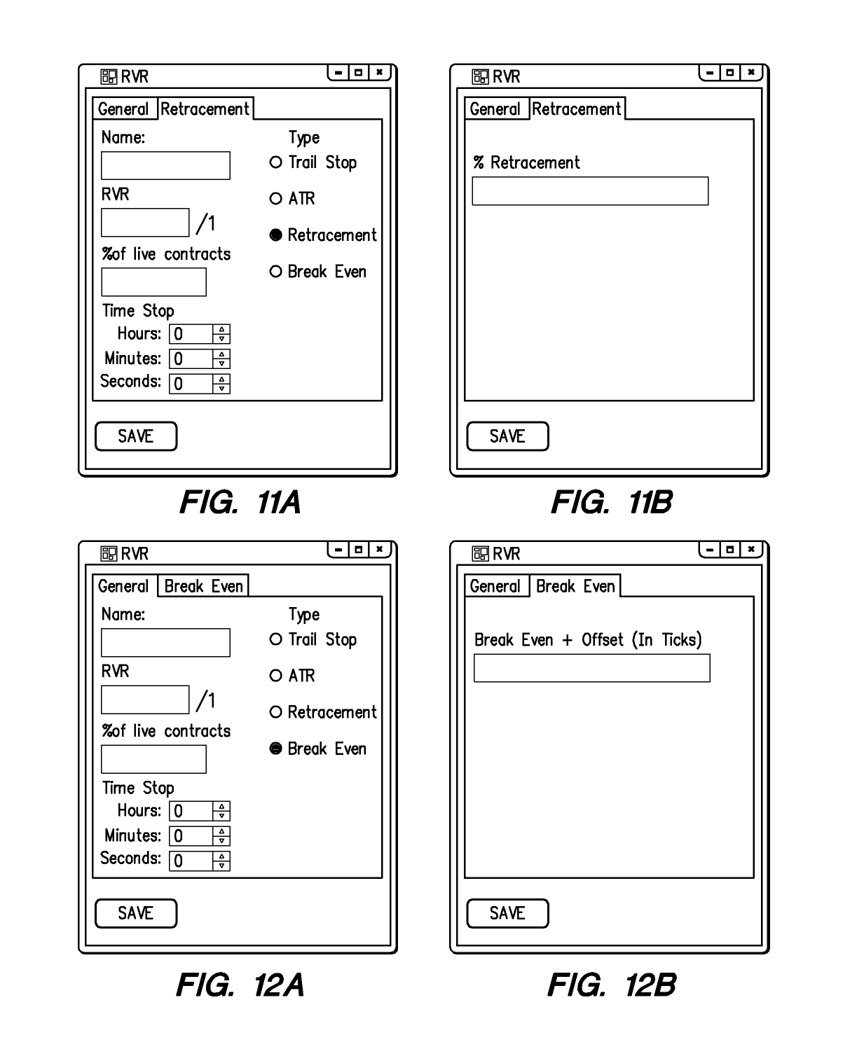

Referring now to FIGS. 8, 9A, 9B, 10A, 10B, 11A, 11B, 12A and 12B, an RVR tab 18 is shown which allows the user to create a new RVR level and combine one or more RVR levels to save the same as an RVR schedule preset 22. On the RVR tab 18 shown in FIG. 8, the user may select the new button 58. Upon selecting the new button 58, the popup screen shown in FIG. 9A is presented to the user. The user may select any one of the RVR types 62 such as Trail Stop 66, ATR, 68, Retracement 70 or Break Even 72. When the user selects one of the RVR types 62, the tab at the top of the pop up will change, as shown in FIGS. 9A, 10A, 11A and 12A. For example, upon selection of the trail stop tab shown in FIG. 9A, the user is presented with parameter inputs for the trail stop as shown in FIG. 9B. Upon selection of the ATR tab shown in FIG. 10A, the user is presented with parameter inputs for the ATR as shown in FIG. 10B. Upon selection of the Retracement tab shown in FIG. 11A, the user is presented with parameter inputs for the Retracement as shown in FIG. 11B. Upon selection of the Break Even tab shown in FIG. 12A, the user is presented with parameter inputs for the Break Even as shown in FIG. 12B. The user may enter the appropriate information in the parameter fields shown in FIGS. 9B, 10B, 11B and 12B.

The user may select a name 60 for the RVR level, enter in the RVR parameter 64 and the % of live contracts parameter 122. Additionally, the user may specify the time stop parameters 116 shown in FIGS. 9A, 10A, 11A and 12A. Once the parameters 64, 60, 62, 119 and those shown in FIGS. 9B, 10B, 11B or 12B are entered (depending on which RVR type 62 is selected), the user may click the save button 74. The RVR level 80 is listed in drop-down menus 80, 82 and 124. To combine RVR levels, the user may click on the new schedule button 90 and enter in a name 132 for a new RVR schedule and click save 128 in the pop up window shown at the bottom of FIG. 8. The new RVR schedule is listed in drop down menu 130. The RVR schedule may have 1 or more RVR levels. Any one of the RVR levels listed in the drop down menu 82 may be added to a RVR schedule preset 22 by selecting the desired RVR level from the dropdown menu 82 and clicking the add button 92. RVR levels can also be removed by selecting the RVR level from dropdown 124 and clicking the remove button 126. Upon clicking add 92 or remove 126, the RVR level is added to or removed from the list 78 of RVR levels. Once RVR levels 80 are specified the trader is ready to create a new RVR schedule 90 which comprises one or more RVR levels.

The types of RVR levels 62 are trail stop options 66, ATR option 68, retracement option 70 and breakeven option 72. The appropriate type of RVR level is selected by selecting the appropriate radio button. The trail stop option 66 may include a regular trail stop option which is a variant of a trail stop. The regular trail stop option 66 requires two user inputs. The first user input is a number of ticks/pips the price must move to trigger an event. The second input is the amount the stop price will move based on previous events being triggered. By way of example and not limitation, the user may specify that when the price moves one tick in the direction of profit, the stop price also moves one tick in the direction of profit. When the market reverses the stop price no longer trails. If new highs or lows are made, the stop price continues to trail. If the market turns and comes down or up to the stop price and hits that level, the trade would be closed.

The ATR option 68 or average true range option is also a variant of the trail stop. This kind of stop is an indicator which measures the securities volatility. The inputs for the ATR trail stop option 68 consists of the period and the multiplier. The period defines the number of bars one wishes to look back to apply the average true range formula. With this period you have a value for ATR. To calculate the price level the ATR trail stop will exit the order, the multiplier is used. The ATR is multiplied by the multiplier to achieve the ATR trail level which is translated to the chart to show the value of the ATR. If the market is in a constant uptrend and the ATR is 1.15 and the multiplier is 2.618, the ATR trail stop will be set at 3.0107 below the highest closing bar in the period calculated. If the market turns in the opposite direction, the ATR value stays constant until the ATR trail value is hit and the trade is exited. Once this happens, the ATR trail value is now on the opposite side of both current price offsets by the ATR value and multiplier. The ATR trail value only changes as higher highs and lower lows are made respectively based on the direction of trade.

The retracement option 70 is a percentage retracement stop loss. This kind of stop loss makes an assumption that once you reach a specific RVR level that the retracement option 70 is activated and the user wants to protect his/her profit. The retracement option 70 is a percentage of profit the user is willing to give up before the trader no longer wants to continue that trade. For example, if a percentage retracement option 70 is selected for the RVR level 2/1 once the RVR level 2/1 is achieved the retracement option would move the stop loss to the specified percentage the user is willing to give up. For example, initial stop loss is set to 5 ticks/pips, when a 2/1 RVR level is achieved the user has 10 tick/pips of profit. If the retracement option 70 is set at 20% the stop loss would be moved to 2 ticks below the RVR level 2/1 price. As the trade progresses and additional ticks/pips or profit are obtained the percentage retracement would be adjusted based on the new level of ticks/pips profit.

The breakeven option 72 manages the exit of a trade or contract within a RVR schedule. The purpose of break even at a given RVR schedule is to move the stop loss to the breakeven (Entry Price) when a specified RVR level is achieved. The user may also set an offset number along with the break even. If the user were to utilize a break even at RVR 2:1 plus an offset of 1, this would mean that once the trade had reached the 2:1 RVR schedule, the stop loss would be moved to the entry price plus 1 tick/pip in the direction of profit. To further clarify, this means if the price came back down to this new set stop loss based on the 2:1 RVR Schedule the trader would exit the trade automatically with 1 tick/pip of profit.

Other options are also contemplated such as the bar count look back trail stop option and the time stop option. The bar count look back trail stop option is a trailing option. The user defines or enters the inputs shown in FIG. 9B. The bar count trail stop option works by looking back the number of bars back as specified in FIG. 9B. Depending on if the executed trade is a Buy, Sell or straddle the highest high or lowest low of the that bars price plus the offset specified in FIG. 9B is used to set the new stop price based on the RVR level specified. As each new bar is created within this RVR level the trail will be recalculated based on the new data available and specified numbers of bar look back. The time stop option is available in two different formats in the system. The user can specify a global time stop 140 (see FIG. 4). This is a static time in which the user wants the trade to close out automatically. The second option 116 for time stop is based within an RVR level (see FIG. 9A). User can specify the amount of time in hours, minutes and seconds in which the trade will automatically close out. This time stop is only active if a specified RVR level is hit within a RVR schedule. The global time stop 140 is always active.

By selecting a predetermined profile including both risk sizing and RVR schedule to enter a trade with one click, the trader is able to identify a market quicker and to enter the trade quicker without being slowed down by having to select these parameters while trading. As a result, the trader is able to enter a market first before others and to obtain a higher probability of receiving an order at a specified price or to receive a higher priority for a market order trade.

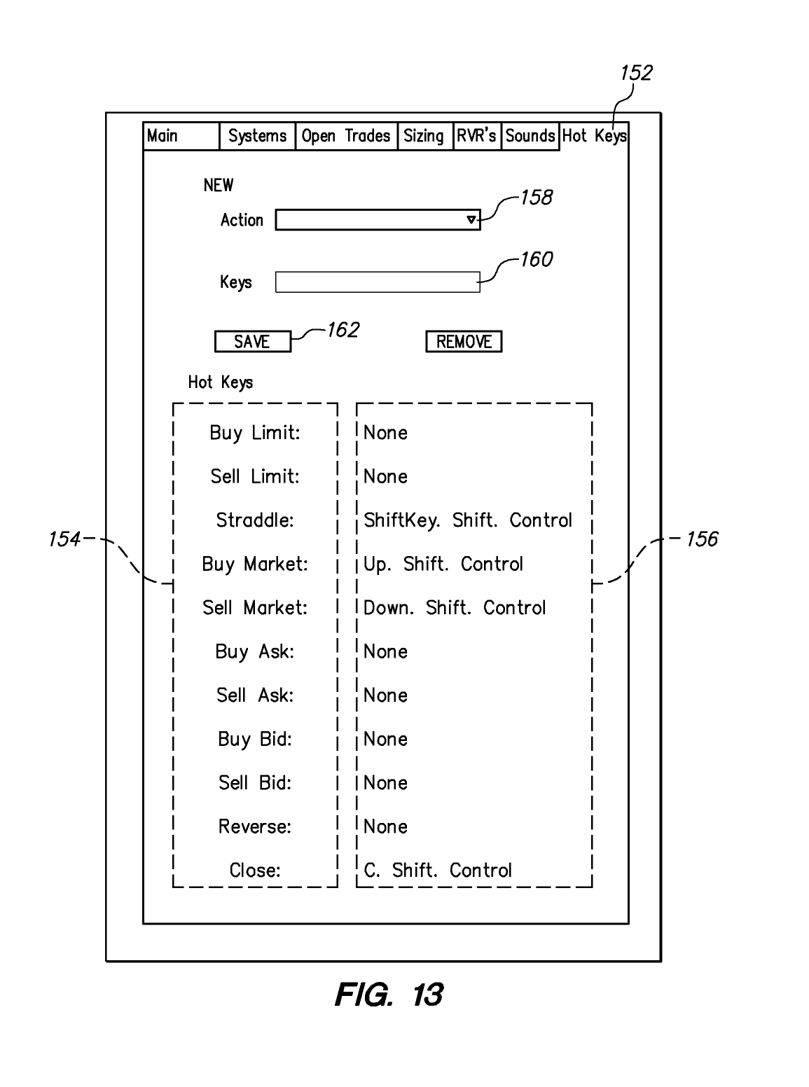

Referring now to FIG. 13, a hotkeys tab 152 is shown. On this page, a plurality of actions 154 may be associated with a corresponding keystroke 156. The action 154 may be selected from a drop-down menu 158. Once selected, the user enters in a series of keystrokes which are then recorded and visually shown in the keys space 160. The user then selects the save button 162 to save the hot key in the system 10.

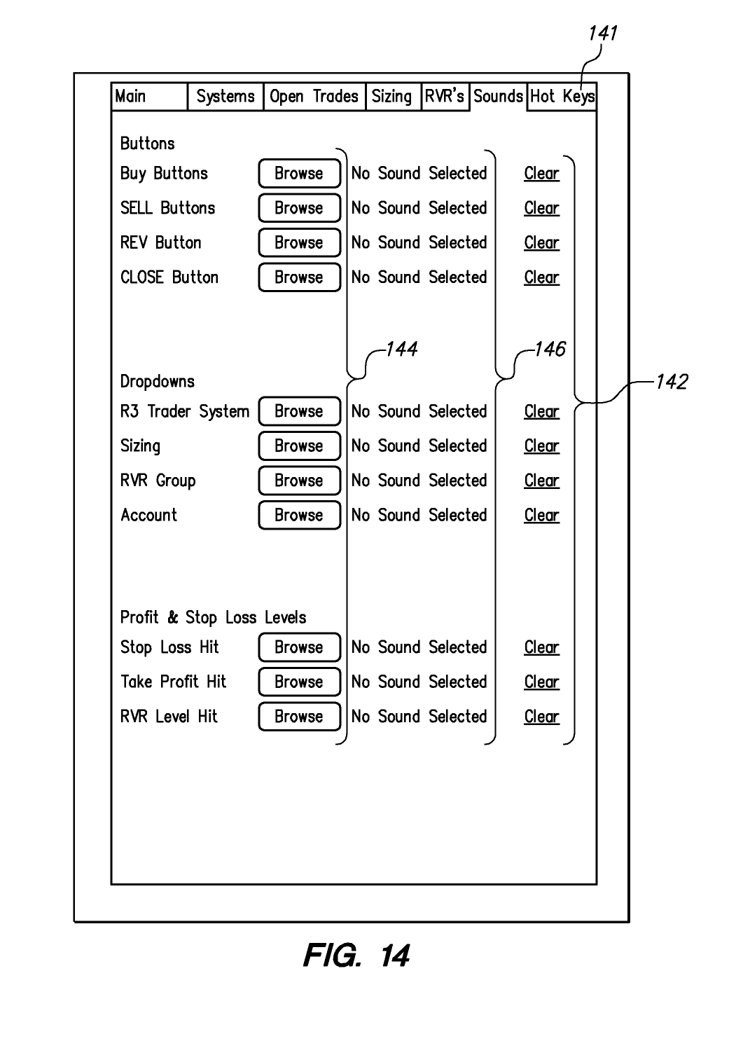

Referring now to FIG. 14, a sounds tab 141 is shown. On this tab, sounds 146 corresponding to particular actions can be specified. The user can browse for audio files saved on their computer by clicking Browse 144 to save that audio file to a particular button, dropdowns or Profit & stop loss levels. If the user wishes to remove the sound from this function they click the Clear 142 link to remove the sound from the corresponding function.

The above description is given by way of example, and not limitation. Given the above disclosure, one skilled in the art could devise variations that are within the scope and spirit of the invention disclosed herein, including various ways of setting up the profiles. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A computer loaded with software for performing the steps of:
setting up one or more profiles for trading a market based on a risk sizing and risk versus reward schedule;
selecting one profile of the one or more profiles;
entering the market based on the selected profile.

2. The computer of claim 1 wherein the entering step includes the step of limiting a trade second in time based on a risk of at least one trade first in time.

3. The computer of claim 2 wherein the at least one trade first in time is open.

4. The computer of claim 1 wherein the setting up step includes the step of selecting one risk sizing option from a group consisting of max sizing option, ATR sizing option and bar count sizing option.

5. The computer of claim 4 wherein the setting up step includes the step of overlaying on the one risk sizing option at least one option from a group consisting of min stop loss option, commission rate option and total open risk option.

6. The computer of claim 1 wherein the setting up step includes the step of setting up a risk versus reward schedule comprising one or more risk versus reward levels wherein the risk versus reward levels are Trail Stop, ATR, Retracement and Break Even.

7. The computer of claim 1 wherein the entering step includes at least one of buying/selling a market or stock or straddling a market or stock.

8. A method of trading a market, the method comprising the steps of: creating two or more entry and exit profiles, the creating step including the steps of:
selecting a risk sizing option from a group consisting of max sizing option, ATR sizing option and bar count sizing option;
selecting a risk versus reward schedule based on two or more risk verses reward levels;
selecting one of the two or more entry and exit profiles;
entering a trade based on the selected risk sizing option;
exiting the trade based on the selected risk versus reward schedule.

9. The method of claim 8 wherein the creating step further includes the step of selecting at least one option from a group consisting of min stop loss option, commission rate option and total open risk option which limits the selected risk sizing option.

10. The method of claim 8 wherein the selecting the risk versus reward schedule includes the step of selecting one or more risk versus reward levels of Trail Stop, ATR, Retracement and Break Even.
